(19) United States
(12) Patent Application Publication
(10) Pub. No.: US 2007/0120691 A1
(43) Pub. Date: May 31, 2007

(54) Device for determining the driving capability of a driver in a vehicle

(76) Inventor: Uwe Peter Braun, Lenzen (DE)

Correspondence Address: WILLIAM COLLARD;COLLARD & ROE, P.C., 1077 NORTHERN BOULEVARD, ROSLYN, NY, 11576, US

(21) Appl. No.: 10/587,798

(22) PCT Filed: Jan. 24, 2005
(86) PCT No.: PCT/EP05/00639

§ 371 Date: Jul. 31, 2006

(30) Foreign Application Priority Data
Feb. 2, 2004 (DE) 10 2004 005 163.1

(51) Int. Cl. G08B 23/00

(52) U.S. Cl. 340/576; 180/271

(57) ABSTRACT

A device is described for determining the driving capability of a driver in a vehicle which has an illumination device (1) for illuminating at least one of the driver's eyes, a picture taking device (2) for taking pictures of the illuminated eye, an evaluation device (3) which serves to evaluate the pictures taken by the picture taking device, and a data storage (4). The device is essentially characterised in that the illumination device (1) illuminates with flash type light or intermittently at least one of the driver's eyes, the evaluation device (3) comparing measured values taken for the driver's pupil reaction by means of the picture taking device (2) with at least one normal value for a pupil reaction stored in the data storage (4), and when the normal value is not reached by the measured values for the pupil reaction, having an effect upon a control device (5) such that the vehicle is prevented from starting up or a vehicle in operational state is prevented from being driven on after it has stopped.

The invention relates to a device for determining the driving capability of a driver in a vehicle, with an illumination device for illuminating at least one of the driver's eyes, a picture taking device for taking pictures of the illuminated eye, an evaluation device which serves to evaluate the pictures taken by the picture taking device, and a data storage.

Every year there are a large number of traffic accidents associated with motor vehicles caused by drivers who fall asleep at the wheel. Various devices have therefore already been proposed which serve to continuously monitor the state of alertness or of vigilance of a vehicle driver, and to warn him in good time when driving before he falls asleep. For this, pictures are taken by a picture taking system of the region of at least one eye and analysed by a downstream picture evaluation system. With devices of this type, as are known e.g. from DE 198 03 158 C1 and DE 196 21 435 A1, the picture evaluation system includes means for recognising lid closure with which increasingly frequent closure of the eyes can be identified, and this is interpreted as increasing tiredness. A warning system device is allocated to the picture evaluation system, and this produces a warning signal for the vehicle driver dependent upon an identified state of tiredness. As well as means for recognising lid closure, the device according to DE 198 03 158 C1 also has means for determining pupil diameter or for detecting pupil diameter oscillations.

Safety in road traffic is not only effected, however, by over-fatigue or drowsiness of drivers; there is also in particular a high risk with drivers who are driving a motor vehicle under the influence of alcohol, narcotics or drugs. In Germany alone, each year approx. 40,000 traffic accidents are caused by alcohol at the wheel, approx. 2,000 of which have fatal consequences.

The object which forms the basis of this invention is to provide in a vehicle a device for determining the driving capability of a driver which is suitable for preventing the vehicle from being started up or driven by a driver who is incapable of driving because he has consumed alcohol or drugs or has taken a narcotic.

This object is achieved according to the invention by a device with the features of claim 1. Preferred and advantageous embodiments of the device according to the invention are specified in the sub-claims.

The device according to the invention comprises an illumination device for illuminating at least one of the driver's eyes, a picture taking device for taking pictures of the illuminated eye, an evaluation device which serves to evaluate the pictures taken by the picture taking device, and a data storage. The illumination device illuminates with a flash type light or at short intermittent intervals at least one of the driver's eyes, the evaluation device comparing measured values taken for the driver's pupil reaction by means of the picture taking device with at least one normal value for a pupil reaction stored in the data storage unit, and when the normal value is not reached by the measured values for the pupil reaction, having an effect upon a control device such that the vehicle is prevented from starting up or, if appropriate, the vehicle in operational state is prevented from being driven on after it has stopped.

Basically, people can not deliberately influence their pupil width or the behaviour of their pupils. The characterisation and analysis of spontaneous pupil behaviour in the dark over several minutes is an objective method which provides information on the level of unconsciously controlled, central nervous activation. A stable pupil width corresponds to a high activation level, i.e. to an awake state, whereas pupil oscillations are a sign of drowsiness. Pupillographic investigations carried out on drug consumers have shown that even with low drug concentrations in the blood, clear failures with regard to pupil reaction to light occur in the form of lethargic pupil reaction or total absence of pupil reaction.

With the illumination device of the device according to the invention at least one of the driver's eyes is illuminated by flash type light or at short intermittent intervals, and the pupil reaction is recorded by means of the picture taking device. The measured values recorded in this way are compared with at least one stored normal value or a band width of admissible normal values in the evaluation device. If the comparison shows an inadmissible deviation of the measured values taken from general normal values for the pupil reaction during driving capability, the vehicle is prevented by the control device of the device according to the invention from starting up or from continuing to be driven after the vehicle in operational state has stopped.

Because in the case of a non-existent or lethargic pupil reaction it is problematic to suddenly prevent the motor vehicle from operating when being driven, the device according to the invention preferably only prevents the motor vehicle from starting up or being driven on when it stops if there is an inadmissible deviation of the pupil reaction measured from the general normal values for driving capability.

The option according to which, if appropriate, the motor vehicle in operational state is prevented from being driven on after it has stopped, is particularly advantageous for the case in which the motor vehicle is first of all operated by a person capable of driving and then, with the engine running, there is a change of driver to a driver who is incapable of driving due to alcohol or drug consumption.

If the device according to the invention detects a lack of or a lethargic pupil reaction, and so the driver's incapability of driving, the control device of the device preferably blocks the release of the engine start-up. Alternatively, or in addition, the control device can then, if appropriate, also block the engagement of at least the forward gears of the vehicle's manual or automatic transmission. The latter is available particularly with electrically shifted transmissions.

A preferred embodiment of the device according to the invention further consists of the evaluation device actuating a signal transmitter which emits acoustic and/or optical warning signals when the stored normal value for a pupil reaction caused by light is not reached by the measurement values recorded for the pupil reaction. This embodiment is advantageous in order to signal the driver's incapability of driving, even during driving if appropriate. Warning signals can be, for example, horn signals, voice signals and/or light signals given out by the vehicle headlights and/or the hazard-warning flashers. Co-travellers and other road users in particular can thus also be made aware of a driver's incapability of driving.

The illumination device of the device according to the invention preferably has at least one flash light source which emits visible light.

According to a further preferred embodiment, the illumination device comprises at least one infra-red light source which emits heat rays outside of the visible colour spectrum. Correspondingly, the picture taking device is then formed by a camera device sensitive to infra-red light. The infra-red light source, which can in particular be an infra-red flashing light source, serves to measure the pupil reaction of the driver when driving. As well as the pupil reaction brought about by external light sources, in particular by the lights of oncoming vehicles, with the camera device sensitive to infra-red light, the size of the cornea surface, the lid closure frequency, the lid closure duration and/or pupil diameter oscillations of at least one of the driver's eyes can be determined. By comparing the corresponding measured values with the corresponding normal values, developing or existing drowsiness of the driver can be determined. If drowsiness is detected, this can once again be signalled by acoustic and/or optical signal transmitters so as to counter the drowsiness of the driver or to warn the driver or third parties.

In connection with this, a further advantageous embodiment of the device according to the invention consists of the evaluation device actuating an illumination device aligned or alignable to the driver's visual field which emits a diffuse, wide area of light which counters the driver's tiredness dependent upon a change to the visible size of the cornea surface, the lid closure frequency, and/or the lid closure duration of the eye and/or the occurrence of pupil diameter oscillations.

So that the device according to the invention can not be circumvented by a driver who is incapable of driving due to alcohol or drug consumption, it is proposed by a further embodiment of the device that biometric data for one or more people relating to iris structure, eye colour, distance between the eyes, eye area, nose size, mouth size and/or face shape can also be stored in the data storage, and that corresponding biometric data of the driver in question can be determined by the picture taking device, the evaluation device for identifying the driver comparing the biometric data established with the stored biometric data, and if the data compared do not correspond within pre-specified tolerance limits, this has an effect upon at least one control device such that the vehicle is prevented from starting up or the vehicle in operational state is prevented from being driven on after it has stopped.

Circumvention of the device according to the invention in that a person capable of driving first of all starts up the motor vehicle and then, when the engine is running, passes control and use of the motor vehicle over to a driver incapable of driving due to alcohol or drug consumption, can in this way be ruled out.

In addition to or alternatively to this, the device according to the invention can also be designed such that in the data storage the biometric data for at least one finger print can be stored, and by means of a sensor, biometric data for a finger print of the driver in question can be taken, the evaluation device for identifying the driver once again comparing the biometric data taken with the stored biometric data, and if the compared data do not correspond within pre-specified tolerance limits, having a effect upon at least one control device such that the vehicle is prevented from starting up or the vehicle in operational state is prevented from being driven on after it has stopped.

Another advantageous embodiment of the device according to the invention is characterised in that the picture taking device, the evaluation device and/or the data storage are provided with at least one interface for signal and/or data transfer. The interface makes possible simple data transfer from and to other mobile or central monitoring and/or data processing equipment. In particular, this interface can be designed as a transmitting/receiving unit for wireless signal or data transfer.

According to a further particularly preferred embodiment, the illumination device and/or the picture taking device are integrated in a vehicle sun visor provided for the driver.

In order to prevent manipulation of the device according to the invention, a further embodiment proposes that if there is a functional failure of the picture taking device and/or a functional failure of the illumination device and/or a functional failure of the signal transmitter emitting an acoustic and/or optical warning signal, the evaluation device has an effect upon at least one control device such that the vehicle is prevented from starting up or the vehicle in operational state is prevented from being driven on after it has stopped.

In the following the invention is described in greater detail by means of drawings showing several examples of embodiments. These show as follows:

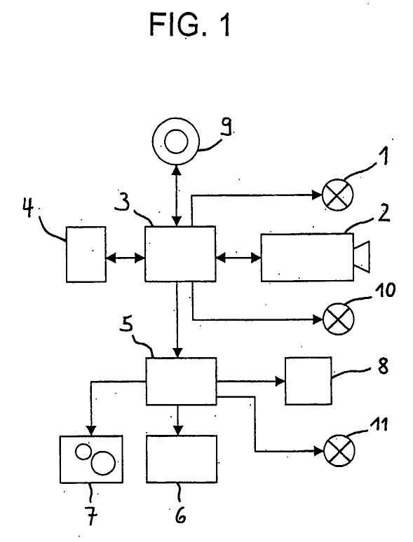

FIG. 1 a block diagram representing a device according to the invention for determining the driving capability of a driver in a vehicle;

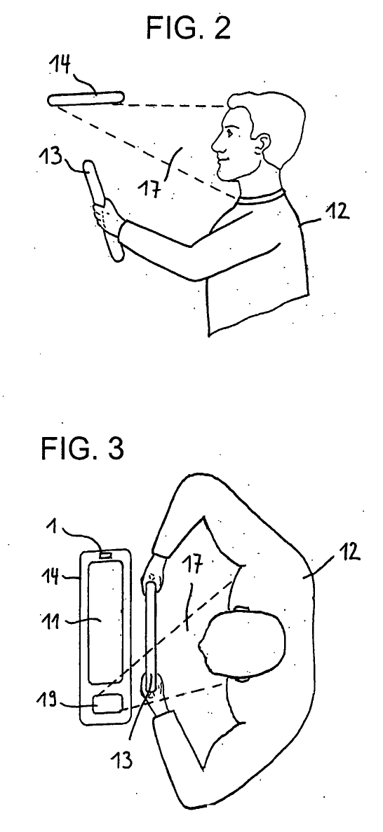

FIG. 2 a schematic representation of a driver, shown in a side view, at the steering-wheel of a motor vehicle;

FIG. 3 a schematic representation of the driver according to FIG. 2 in a top view;

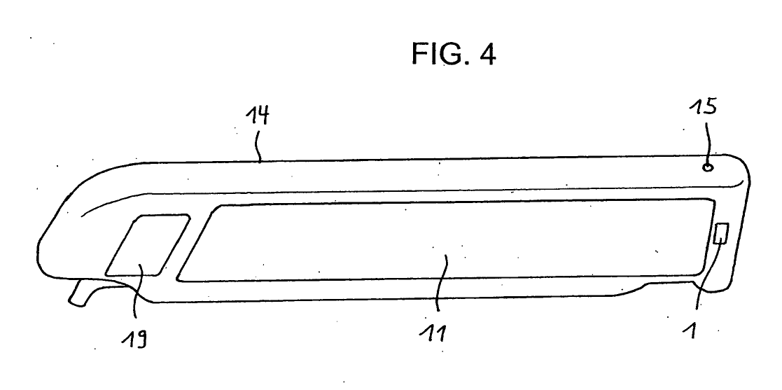

FIG. 4 a perspective representation of a folded away sun visor from the driver's viewpoint;

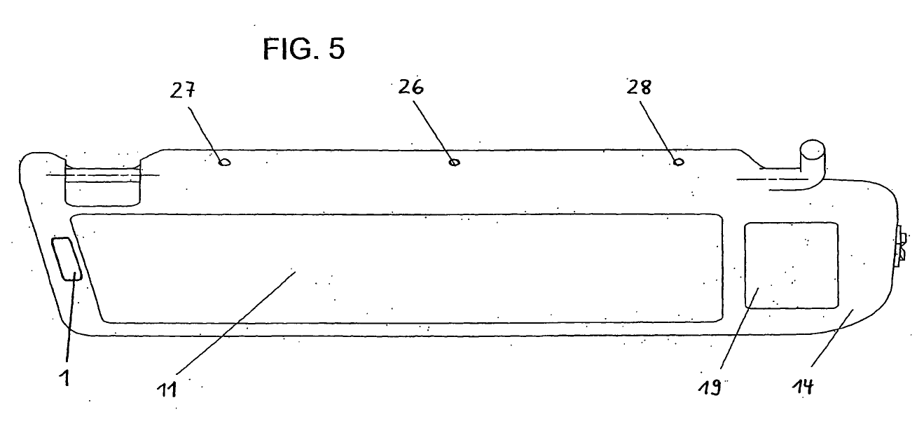

FIG. 5 a perspective representation of a sun visor according to FIG. 4 from the outside viewed in the direction of the driver;

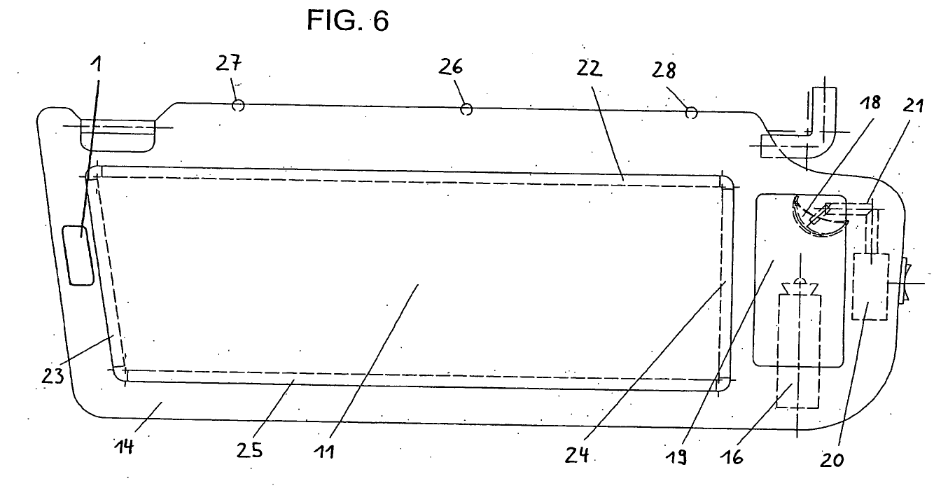

FIG. 6 a further perspective representation of the sun visor according to FIG. 4;

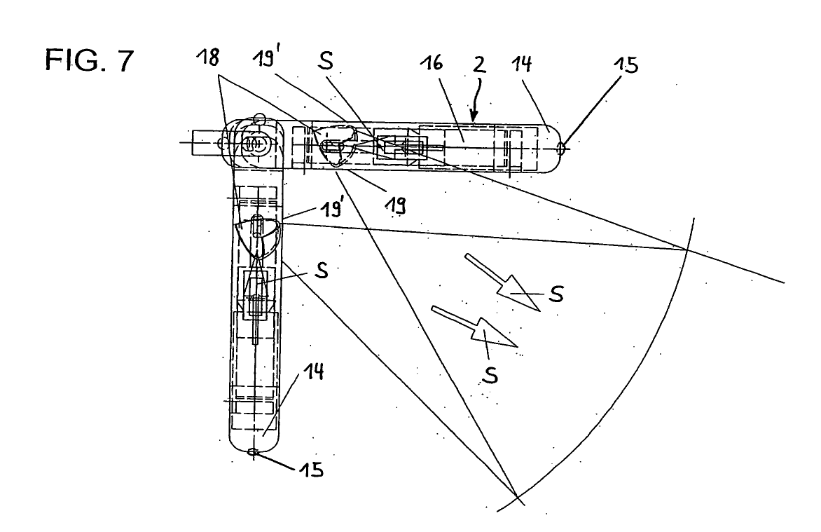

FIG. 7 a cross-sectional representation of the sun visor according to FIG. 4 in a folded up position and in a folded down position; and

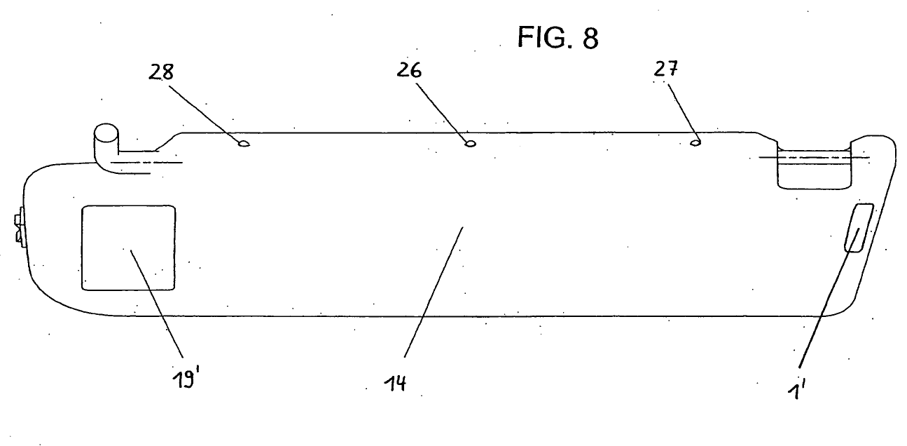

FIG. 8 a further perspective representation of the sun visor according to FIG. 4 in a folded down position from the driver's viewpoint.

The device represented schematically in FIG. 1 has an illumination device 1 with which at least one eye, and preferably both of the eyes of a driver of a motor vehicle is/are illuminated when he has taken position in the driver's seat. The occupancy of the driver's seat is detected by one or more appropriate sensors, for example a pressure sensor (not shown) and/or an optical sensor, in particular a camera. The illumination device 1 consists of a flash light which emits visible light, or a light which emits visible light in short intermittent intervals. The intensity or brightness of the irradiated light is a function of time here. The pupil diameter of the illuminated eye changes with the light emitted or its brightness.

A picture taking device 2 is allocated to the illumination device 1, and this consists of a camera with which pictures of the illuminated eye or eyes of the driver are taken. The pictures taken are evaluated with an evaluation device 3 which is provided with a data storage 4.

The evaluation device 3 compares the measured values for the driver's pupil reaction obtained from the pictures taken with normal values for pupil reaction which are stored in the data storage 4. The comparison relates in particular to the pupil reaction time. Because the pupil reaction time can have different values for different people capable of driving, and so lies within a certain band width, a specific limit value or set value for the normal pupil reaction time for driving capability is preferably stored in the data storage 4.

If the pupil reaction time measured fails to reach the normal value (set value) or limit value (minimum value), the evaluation device 2 has an effect upon a control device 5 such that the motor vehicle is prevented from starting up or the motor vehicle in operational state is prevented from being driven on after it has stopped.

In the example of the embodiment shown, the control device 5 works in conjunction with the ignition system 6, for example with the ignition lock switch and/or the starter, so that if required the engine start up is blocked. Moreover, in FIG. 1 the possibility is also indicated whereby by means of the control device, engagement of at least the forward gears of the manual or automatic transmission 7 of the vehicle can be blocked.

The picture taking device 2, the evaluation device 3, the data storage 4 and/or the control device 5 are preferably provided with at least one interface by means of which there can be external signal and/or data transfer.

Furthermore, attached to the evaluation device 3 or the control device 5 allocated to it is a signal transmitter 8 which with corresponding actuation emits an acoustic and/or optical warning signal. The signal transmitter 8 is actuated by means of the control device 5 of the evaluation device 3 when the latter detects failure to reach the “normal” pupil reaction time stored by the actual pupil reaction time measured for the driver.

Furthermore, attached to the evaluation device 3 is a finger print sensor 9 which serves to identify the driver. The biometric data of a finger print determined by the sensor can be stored in the data storage unit 4. The evaluation device 3 compares the finger print taken with the data of one or more stored finger prints. If the compared data do not correspond within pre-specified tolerance limits, the evaluation device 3 effects the control device 5 which then prevents the vehicle from being started up or if appropriate, prevents the vehicle being driven from driving on after it has stopped. In this case, the vehicle is only allowed to start up again or to be driven on when the evaluation device 3 has positively established the driving capability of the driver who is “unknown” with regard to his finger print by testing the pupil reaction time.

Alternatively or in addition, other biometric data of one or more people can also be stored in the data storage 4. Preferably, biometric data such as iris structure characteristics, eye colour, distance between the eyes, eye area, nose size, mouth size and/or face shape of the driver in question are determined by the picture taking device and stored in the data storage 4. In order to identify the driver, the evaluation device 3 then once again compares the biometric data determined with the stored biometric data. If the data compared do not correspond within pre-specified tolerance limits, a corresponding signal is emitted to the control device 5 which then blocks the vehicle from starting up or the vehicle in operational state from driving on after it has stopped. In this case too, the vehicle is only allowed to start up again or to be driven on when the evaluation device 3 has positively established by testing the pupil reaction time the driving capability of the driver “unknown” with regard to his established biometric data.

Furthermore, the device shown in FIG. 1 has an infra-red light source 10 aligned or alignable to the driver's visual field. The picture taking device 2 is correspondingly formed by a camera device sensitive to infra-red light or comprises this type of camera device.

The evaluation device 3 is preferably designed such that it actuates an illumination device 11 aligned or alignable to the driver's visual field and which emits a diffuse, wide area of light which counters the driver's tiredness dependent upon a change to the visible size of the cornea surface, the lid closure frequency and/or the lid closure duration of the driver's eye or eyes detected by the camera device 2 and/or when pupil diameter oscillations occur. This is described in greater detail with reference to FIGS. 2 to 8.

The illumination devices 1, 10 and 11 and the picture taking device 2 of the device according to the invention can preferably be integrated in a sun visor provided for the driver.

FIGS. 2 and 3 show a driver 12 at the steering wheel 13 of a motor vehicle. As is customary, the driver is provided with a foldable sun visor 14, FIG. 2 showing the situation in which the sun visor 14 is in its folded up position. This situation generally corresponds to the situation of driving at night or driving through a long tunnel.

The illumination device 1 serving to determine driving capability with which at least one of the driver's 12 eyes is illuminated by flash-type light or intermittently, is made in double and is disposed on both sides of the sun visor 14. Preferably, of the two illumination devices 1, 1′, only the illumination device which is facing the visual field of the driver 12 dependent upon the position of the sun visor 14 is switched on.

On the front edge of the sun visor 14 which is facing towards the driver 12 when the sun visor 13 is in the folded up position, a light sensor 15 is disposed with which the brightness is measured in the region of the visual field of the driver 12.

Furthermore, the sun visor 14 is provided with a picture taking device comprising infra-red illumination for taking pictures of the region of at least one of the driver's eyes.

An evaluation device 3 is allocated to the picture taking device 2, and this evaluates pictures taken by the picture taking device 2 and actuates the illumination device 11 aligned or alignable to the visual field of the driver 12 and which emits a wide area of light countering the driver's tiredness dependent upon a change to the visible size of the cornea surface, the lid closure frequency and/or the lid closure duration of the eye.

Establishing a critical tiredness state of the driver 12 can be based in particular upon the so-called cornea reflection method with which the reflection level of the cornea, which depends upon the degree of opening of the eyelid, is measured.

The evaluation device 3 can be realised by means of an appropriate computer (vehicle computer) or microprocessor with a storage device. Preferably, the evaluation device 3 can also be integrated in the sun visor 14. It can, however, also be disposed at another location within the vehicle. The computer or microprocessor is then in dialogue with the electrooptical and electronic components of the sun visor 14 by means of a data and voltage supply connection.

Furthermore, the evaluation device 3 is connected to a warning signal device (not shown in FIGS. 2 to 8) which warns the driver by means of an optical and/or acoustic warning signal when the evaluation device 3 has identified that he is in a critical state of tiredness.

The picture taking device 2 comprises a miniature camera 16 which has a light-sensitive CCD array, a lens, a shutter and a focussing device. The camera 16, which is disposed in the sun visor 14 such that it can not be seen by the driver, measures the visual field 17 of the driver by means of deflection optics 18 in the form of a mirror which is preferably convex in form. Furthermore, in the optical path S of the camera 16, a beam splitter 19 is disposed which covers an opening within the wall or covering of the sun visor 14 and is visible to the driver 12 (see FIGS. 3 and 4).

A second corresponding beam splitter 19′ is disposed on the opposite side of the sun visor 14 and can also be seen by the driver when the sun visor 14 is folded down. As can be seen in particular in FIG. 7, the two beam splitters 19, 19′ are disposed such that in the folded up position of the sun visor 14 by means of the beam splitter 19, and in the folded down position by means of the beam splitter 19′, the camera 16 takes pictures of the region of at least one of the driver's eyes.

The tilted mirror 18 is moveably mounted. The spatial position of the tilted mirror 18 is set automatically by means of an actuator having a motor 20 and a transmission 21 dependent upon the sitting position and size of the driver. The motor 20 of the actuator is actuated for this by the evaluation device. In the data storage allocated to the evaluation device, one or more reference pictures are stored which correspond to a visual field (visual sample) to be identified. The evaluation device 3 compares the pictures taken by the camera 16 with the reference pictures and in case of a deviation between the pictures taken and the reference picture exceeding a specific limit value, adjusts the tilted mirror 18 until the pictures taken correspond to the reference picture/s again to a certain degree.

The illumination device 11 of the device according to the invention preferably consists of a plate shaped, substantially rectangular light conductor which has a wide area light emission surface and emits diffuse light. The light conductor is made of glass or of a vitreous plastic, for example perspex. On the side lying opposite the light emission surface, the light conductor preferably has a reflective coating or imprint. In the example of the embodiment shown, the light emission surface takes up more than half of a flat side of the sun visor 14. It is only disposed on the side of the sun visor 14 which points in the direction of travel when the sun visor 14 is in the folded down position.

On the edges of the light conductor are disposed different light sources, their light respectively being directed via the narrow edge areas into the light conductor (see FIG. 6). On the upper longitudinal edge of the light conductor is disposed a band of light diodes 22 by means of which visible light is directed into the light conductor. On each of the two crosswise edges is disposed a band of infra-red light light diodes 23 and 24. On the lower longitudinal edge there is a band of light diodes 25 which emits UV light, in fact UV A radiation in the range of between 320 and 400 nm, and/or light in a spectrum of preferably 430 to 620 nm. Trials have shown that light radiation with this spectrum effectively counters tiredness in people being tested.

The upper edge of the sun visor 14 has an opening into which a light sensor 26 is inserted. The light sensor 26 serves to determine the external brightness and is connected to an electronic control by means of which the intensity of the visible and invisible light radiation emitted by the illumination device 11 is controlled dependent upon the light radiation of the environment falling onto the light sensor 26. Preferably, the computer or microprocessor of the evaluation device 3 comprises this electronic control.

Besides the light sensor 26, disposed on the upper edge of the sun visor 14 are disposed two further light sensors 27, 28 on the right and on the left. The light sensors 27, 28 serve to measure the light radiation of oncoming vehicles or external dazzling sources when driving at night or driving through long tunnels. The light sensors 27, 28 are connected to an electronic control which controls at least the visible light radiation emitted from the illumination device 11 dependent upon the light radiation falling onto the light sensors 27, 28 from the dazzling source. In addition however, the emitted UV radiation can be controlled dependent upon the dazzling radiation detected. Preferably, the computer or microprocessor of the evaluation device 3 also undertakes this control.

In the folded down position of the sun visor 14, the light emission surface is not facing towards the driver's visual field 17. However, this is not advantageous either because the sun visor 14 is generally only folded down during journeys during the day, i.e. when the sun is dazzling the driver. In the folded down position too, the camera 16 can however establish the visual field 17 of the driver by means of the beam splitter 19′. It is therefore guaranteed in the folded down position of the sun visor 14 that dependent upon a state of tiredness of the driver determined by the evaluation device, a warning signal is issued to him by means of an appropriate optical and/or acoustic signal device.

The sun visor 14 described above is therefore a multifunctional sun visor which as well as its conventional function additionally assumes the functions of:
determining the driving capability of a driver,
monitoring the alertness of a driver,
automatically emitting a light countering the tiredness of the vehicle driver, and
preventing dazzling of the vehicle driver by the driving lights of oncoming vehicles when driving in the dark.

1 to 12 (canceled).

13. A device for determining the driving capability of a driver in a vehicle with an illumination device (1) for illuminating at least one of the driver s (12) eyes, a picture taking device (2) for taking pictures of the illuminated eye, an evaluation device (3) which serves to evaluate the pictures taken by the picture taking device (2), and a data storage (4), the illumination device (1) illuminating with flash type light or intermittently at least one of the driver s (12) eyes, the evaluation device (3) comparing the measured values taken for the driver s pupil reaction by means of the picture taking device (2) with a normal value for a pupil reaction stored in the data storage (4), and when the normal value is not reached by the measured values for the pupil reaction, having an effect upon the control device (5) such that the vehicle is prevented from starting up, or the vehicle in operational state is prevented from being driven on after it has stopped, wherein biometric data of at least one finger print can be stored in the date storage (4) and biometric data of a finger print of the driver in question can be determined by means of a sensor (9), and/or biometric data for at least one person relating to their iris structure, eye colour, distance between the eyes, eye area, nose size, mouth size and/or face shape can be stored in the data storage (4) and corresponding biometric data of the driver in question can be determined by the picture taking device (2), the evaluation device (3) for identifying the driver comparing the biometric data established with the stored biometric data, and if the data compared do not correspond within pre-specified tolerance limits having an effect upon at least one control device (5) such that the vehicle is prevented from starting up, or the vehicle in operational state is prevented from being driven on after it has stopped.

14. The device according to claim 13, wherein an engine start up can be prevented by means of the control 5 device (5).

15. The device according to claim 13, wherein by means of the control device (5) engagement of at least the 10 forward gears of the manual or automatic transmission (7) of the vehicle can be blocked.

16. The device according to claim 13, wherein when the measured values for the pupil reaction fail to reach the normal value for a pupil reaction stored, the evaluation device (3) actuates a signal transmitter (8) which emits an acoustic and/or optical warning signal.

17. The device according to claim 13, wherein the illumination device (1) has at least one flash light source.

18. The device according to claim 13, wherein the illumination device has at least one infra red light source (10) which emits heat rays outside of the visible colour spectrum, the picture taking device (2) being formed by a camera device (16) sensitive to infra red.

19. The device according to claim 13, wherein the picture taking device (2), the evaluation device (3) and/or the data storage (4) are provided with at least one interface for signal and/or data transfer.

20. The device according to claim 13, wherein the illumination device (1) and/or the picture taking device (2) are integrated in a vehicle sun visor (14) provided for the driver (12).

21. The device according to claim 13, wherein the evaluation device (3) actuates an illumination device (11) aligned or alignable to the visual field of the driver and which emits a diffuse, wide area of light which counters the driver s tiredness dependent upon a change to the visible size of the cornea surface, the lid closure frequency and/or the lid closure duration of the eye and/or the occurrence of pupil diameter oscillations.

22. The device according to claim 13, wherein if there is a functional failure of the picture taking device (2) and/or a functional failure of the illumination device (1) and/or a functional failure of the signal transmitter (8) emitting an acoustic and/or optical warning signal, the evaluation device (3) has an effect upon at least one control device (5) such that the vehicle is prevented from starting up or a vehicle in operational state is prevented from being driven on after it has stopped.
